(19) United States
(12) Patent Application Publication
(10) Pub. No.: US 2026/0187019 A1
(43) Pub. Date: Jul. 2, 2026

(54) USB SHARING DEVICE AND COMMUNICATION TRANSPARENT TRANSMISSION METHOD THEREFOR

(71) Applicant: NANJING QINHENG MICROELECTRONICS CO., LTD., Nanjing (CN)

(72) Inventors: Shuai LIU, Nanjing (CN); Jiangxin MAO, Nanjing (CN); Chunhua WANG, Nanjing (CN)

(73) Assignee: NANJING QINHENG MICROELECTRONICS CO., LTD., Nanjing (CN)

(21) Appl. No.: 19/366,611

(22) Filed: Oct. 23, 2025

(30) Foreign Application Priority Data
Jan. 2, 2025 (CN) 2025100031686

(51) Int. Cl. G06F 13/42

(52) U.S. Cl. CPC G06F 13/4282; G06F 2213/0042

(57) ABSTRACT

The present invention discloses a USB sharing device and a communication transparent transmission method therefor. The communication transparent transmission method comprises the following steps of: establishing, by the USB sharing device, a corresponding relationship between a USB download endpoint of one side and a USB upload endpoint of the other side; creating a pipe endpoint, wherein the pipe endpoint receives shared data downloaded from a first computing device, and different pipe endpoints are specified for different usages of the shared data; and transmitting the shared data from the pipe endpoint to the USB upload endpoint of the other side according to the corresponding relationship, and uploading the shared data to a second computing device through the USB upload endpoint of the other side. The invention can achieve a transparent transmission effect of shared data, and has high transmission efficiency and strong expansibility.

### CROSS-REFERENCE TO RELATED APPLICATIONS

This application claims priority to Chinese Patent Application Ser. No. CN2025100031686 filed on 2 January 2025.

### TECHNICAL FIELD

The present invention belongs to the technical field of data communication, and particularly relates to a USB sharing device and a communication transparent transmission method therefor.

### BACKGROUND

With the development of the times, people often use a desktop computer and a laptop, or even more than three computers at the same time in modern office work or daily life, and file sharing between computers or cross-screen sharing of keyboard/mouse has become a demand. As a standard interface of computer and mobile phone, a USB is suitable as a connection interface for information and device sharing between computers because of the properties of high speed and reliability, which is efficient, can support sharing of more contents, and can greatly improve working efficiency in a multi-computer office environment.

There are many existing data sharing devices and methods, but in existing solutions, the sharing device realizes a multi-purpose data method according to data in a format of command plus data, wherein a controller needs to make recognition according to a command set first to decide a communication mode. For example, the prior art CN101350001A provides a solution which is capable of realizing data sharing and transmission between two computers, wherein an internal architecture of the solution is as shown in FIG. 1, and a flow chart of a transmission method is as shown in FIG. 2. The device comprises a first device, a second device and a controller, wherein two ends of the first device and the second device are connected with two computers respectively, and different types (different command sets) of communication commands generated on one computer may be transmitted through one of the devices, and must be transmitted in the same command format due to the limitation of a system driver. Therefore, data must be packaged before transmission, the controller needs to intercept each communication command during transmission, and differentiate, recognize and process a customized communication protocol or an existing communication protocol, comprising transmitting some communication commands to the other device, and after the other device receives the communication commands, the commands need to be unpacked and transmitted to the other computer, so as to complete data or file sharing and transmitting. This method has many procedures and a complicated process. This transmission method needs to intercept, recognize and analyze each communication command through a software program, which is equivalent to that all staffs in a whole unit share a telephone line, a telephone number and a manual switchboard, so that the communication efficiency is relatively low and the data transmission efficiency is poor.

Copy line products on sale in the market use controller chips many years ago and implementation methods based on these chips. With the rapid development of integrated circuits, computers have higher configuration and performance. In this case, how to provide a more efficient data sharing scheme is a problem that needs to be solved.

### CONTENT

Objective of the invention: in order to solve the problem of low data sharing efficiency in the prior art, the present invention provides a USB sharing device and a communication transparent transmission method therefor.

Technical solution: a communication transparent transmission method for a USB sharing device is provided, which comprises the following steps of:

establishing, by the USB sharing device, a corresponding relationship between a USB download endpoint of one side and a USB upload endpoint of the other side to make the USB download endpoint of one side in one-to-one correspondence with the USB upload endpoint of the other side, wherein one side refers to a side connected with a first computing device; and the other side refers to a side connected with a second computing device;

connecting the USB sharing device with the first computing device and the second computing device, and recognizing the USB sharing device as at least one USB vendor specific class device by the first computing device, and as at least one USB class device by the second computing device; and allocating the USB download endpoint of one side of the USB sharing device with a USB pipe by the first computing device, and defining the USB download endpoint allocated with the USB pipe as a pipe endpoint, wherein a plurality of pipe endpoints are provided;

acquiring, by a first shared data acquisition module, shared data of the first computing device and transmitting the shared data to a first driver module;

transmitting, by the first driver module, the shared data to the specified pipe endpoint through the USB pipe, wherein the shared data have different usages, and different pipe endpoints are specified for the different usages;

receiving, by the pipe endpoint, the shared data of the first computing device;

transmitting the shared data from the pipe endpoint to the USB upload endpoint of the other side according to the corresponding relationship, and uploading the shared data to the second computing device through the USB upload endpoint of the other side.

Further, the usages of the shared data comprise at least one of being used for a shared device and being used for shared information, and when the shared data are used for the shared device, pipe endpoints are different for different devices; and when the shared data are used for the shared information, pipe endpoints are different for different information.

Further, a method for transmitting the shared data from the pipe endpoint to the USB upload endpoint of the other side according to the corresponding relationship comprises: making the pipe endpoint and the USB upload endpoint of the other side share a same buffer.

Further, a method for transmitting the shared data from the pipe endpoint to the USB upload endpoint of the other side according to the corresponding relationship comprises: making the pipe endpoint and the USB upload endpoint of the other side have different buffers respectively, and copying data stored in the buffer of the pipe endpoint into the buffer of the USB upload endpoint of the other side.

A USB sharing device is provided, wherein the USB sharing device is capable of being recognized as at least one USB vendor specific class device by a first computing device, and capable of being recognized as at least one USB class device by a second computing device; and comprises:

a first USB port used for connecting with the first computing device;

a second USB port used for connecting with the second computing device;

a USB download endpoint of one side, which is capable of being allocated with a USB pipe by the first computing device, wherein the USB download endpoint allocated with the USB pipe is defined as a pipe endpoint, and a plurality of pipe endpoints are provided; and the pipe endpoint is used for receiving shared data downloaded from the first computing device, the shared data have different usages, and different pipe endpoints are specified for the different usages;

a sharing control unit used for establishing a corresponding relationship between the USB download endpoint of one side and a USB upload endpoint of the other side to make the USB download endpoint of one side in one-to-one correspondence with the USB upload endpoint of the other side;

the USB upload endpoint of the other side used for receiving the shared data transmitted from the corresponding pipe endpoint, and uploading the shared data to the second computing device through the USB upload endpoint of the other side, wherein one side refers to a side connected with the first computing device; and the other side refers to a side connected with the second computing device;

a first shared data acquisition module, which is a software module installed on the first computing device, and used for acquiring shared data of the first computing device and transmitting the shared data to a first driver module;

the first driver module, which is driver software with a pipe transparent transmission function installed on the first computing device, and used for transmitting the shared data of the first computing device to the specified pipe endpoint through the USB pipe.

Further, the usages of the shared data comprise at least one of being used for a shared device and being used for shared information, and when the shared data are used for the shared device, different pipe endpoints are provided for different devices; and when the shared data are used for the shared information, pipe endpoints are different for different information.

Further, the pipe endpoint and the USB upload endpoint of the other side share a same buffer.

Further, the USB sharing device may also be recognized as at least one USB vendor specific class device by the second computing device.

Further, the USB sharing device is capable of being recognized as at least one USB mass storage device by at least one of the first computing device and the second computing device.

Further, the USB sharing device is capable of being recognized as at least one USB vendor specific class device and at least one USB class device by the first computing device, and also capable of being recognized as at least one USB vendor specific class device and at least one USB class device by the second computing device; and further comprises:

a USB download endpoint of the other side, which is capable of being allocated with a USB pipe by the second computing device, wherein the USB download endpoint allocated with the USB pipe is defined as a pipe endpoint, and a plurality of pipe endpoints are provided; and the pipe endpoint is used for receiving shared data downloaded from the second computing device, the shared data have different usages, and different pipe endpoints are specified for the different usages;

a sharing control unit further used for establishing a corresponding relationship between the USB download endpoint of the other side and a USB upload endpoint of one side to make the USB download endpoint of the other side in one-to-one correspondence with the USB upload endpoint of one side;

the USB upload endpoint of one side used for receiving the shared data transmitted from the corresponding pipe endpoint, and uploading the shared data to the first computing device through the USB upload endpoint of one side;

a second shared data acquisition module, which is a software module installed on the second computing device, and used for acquiring shared data of the second computing device and transmitting the shared data to a second driver module;

the second driver module, which is driver software with a pipe transparent transmission function installed on the second computing device, and used for transmitting the shared data of the second computing device to the specified pipe endpoint through the USB pipe.

Compared with the prior art, the present invention provides the USB sharing device and the communication transparent transmission method therefor, and has the following beneficial effects.

1 In the prior art, the command must be transmitted in a specific command format and in a specific way, so that each shared data needs to be packaged before downloading and then transmitted, thereby being cumbersome and time-consuming in whole process. In this method, after the software acquires the shared data to be transmitted by the computer, the shared data are directly transmitted to the specified pipe endpoint through the driver software with the transparent transmission function and a system host, without transmitting the data in a format of command plus data, and only the data are transmitted, so that a USB bandwidth is not wasted, efficiency is high, and processes of packaging by the computing device and package command recognition by the sharing device are also omitted, thereby achieving a high speed.

2 During command transmission in the prior art, the commands need to be intercepted, recognized and differentiated one by one with software, so that the process is cumbersome and inefficient. In this device, the USB vendor specific class device contains a plurality of USB endpoints, and by using the characteristic that the USB vendor specific class device has no specified protocol format and supports multiple endpoints, the present invention establishes a one-to-one corresponding relationship between the computer and the USB download endpoint, and between the USB download endpoint and the USB upload endpoint, so that an effect that different data may be transmitted through different and independent transmission paths is achieved, the shared data access to a destination directly, and the controller does not need to intercept, recognize, differentiate and process the commands one by one during transmission, thereby directly omitting an inefficient and cumbersome intermediate link.

3 In this method, the shared data are the same before transmitting and after receiving, so that a transparent transmission effect is achieved, and the packaging by the computing device and one-by-one command intervention or processing by the shared device are not needed, so that the transmission is more efficient and the expandability is stronger. This method is equivalent to that each staff has a different external direct dial telephone number, an external telephone is dialed directly, the shared data access to a target directly, and even receiving and transmitting channels are independent relatively, so that transmission efficiency of USB sharing between the computing devices can be improved, thereby avoiding an influence of recognition and judgment in the prior art on the speed.

### BRIEF DESCRIPTION OF THE DRAWINGS

FIG. 1 is a schematic diagram of an architecture of the prior art;

FIG. 2 is a flow chart of a method of the prior art;

FIG. 3 is a flow chart of a communication transparent transmission method for a USB sharing device in the embodiment;

FIG. 4 is a schematic diagram of data transmission of the USB sharing device in the embodiment;

FIG. 5 is a schematic diagram of data transmission of a USB sharing device with two-way transmission.

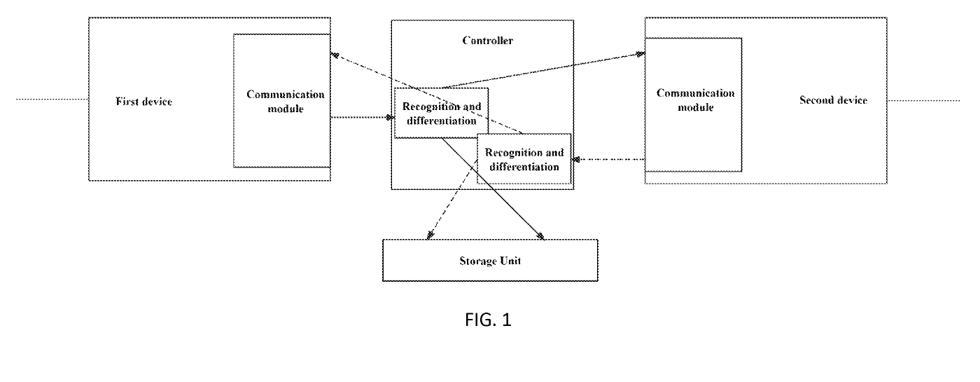

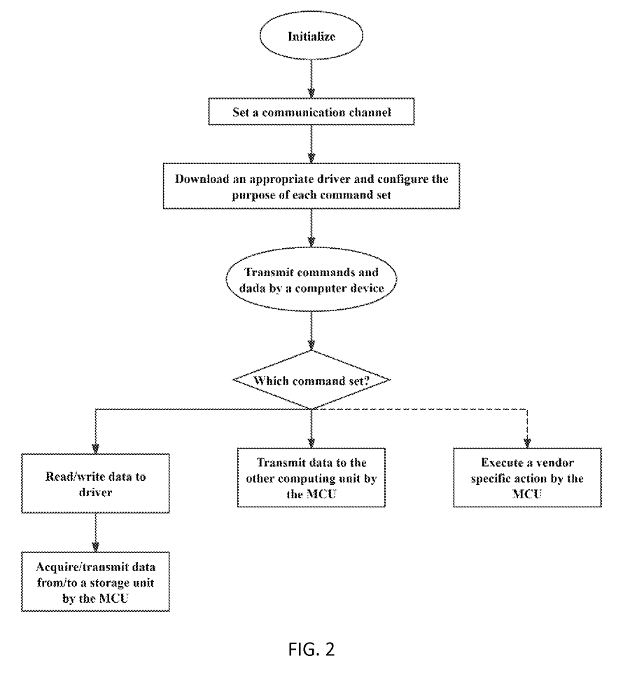

### DETAILED DESCRIPTION

The present invention is further explained and described hereinafter with reference to the drawings and specific embodiments.

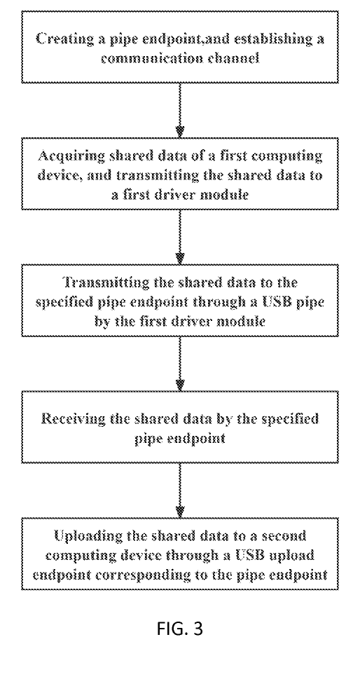

A communication transparent transmission method for a USB sharing device, as shown in FIG. 3, comprises the following steps.

The USB sharing device establishes a corresponding relationship between a USB download endpoint of one side and a USB upload endpoint of the other side to make the USB download endpoint of one side in one-to-one correspondence with the USB upload endpoint of the other side, wherein one side refers to a side connected with a first computing device; and the other side refers to a side connected with a second computing device.

The USB sharing device is connected with the first computing device and the second computing device, the USB sharing device provides USB recognition information, so as to be recognized as at least one USB vendor specific class device by the first computing device, or recognized as other USB vendor specific class devices or other USB devices excluding the USB vendor specific class devices; and the USB sharing device provides USB recognition information, so as to be recognized as at least one USB class device by the second computing device, or recognized as other USB class devices or other USB devices excluding the USB class devices. The USB class device is a USB function device, which is generally directly managed by an operating system or managed by a built-in device driver. The USB vendor specific class device refers to a USB device that needs to be provided with driver software with a pipe transparent transmission function. The USB download endpoint of one side of the USB sharing device is allocated with a USB pipe by the first computing device, wherein the USB download endpoint allocated with the USB pipe is defined as a pipe endpoint, a plurality of pipe endpoints are provided, and at least two pipe endpoints are provided.

A first shared data acquisition module acquires shared data of the first computing device and transmits the shared data to a first driver module, and the driver module herein is usually driver software or a USB interface library in the operating system of the computing device.

The first driver module transmits the share data to the specified pipe endpoint through the USB pipe, wherein the shared data have different usages, and different pipe endpoints are specified for the different usages. The pipe endpoint receives the shared data of the first computing device.

The shared data are uploaded to the second computing device through the USB upload endpoint of the other side corresponding to the pipe endpoint according to the corresponding relationship.

The usages of the shared data comprise at least one of being used for a shared device and being used for shared information, and when the shared data are used for the shared device, pipe endpoints are different for different devices; and when the shared data are used for the shared information, pipe endpoints are different for different information.

The shared device is determined by a USB endpoint of a USB class device connected to an opposite end, the USB class device is a USB functional device, which may be a keyboard, a mouse, a touch pad, a touch screen, a handwriting board and other HID devices, or a USB printer, a USB communication device and the like, comprising multiple devices in different types and multiple devices in the same type, for example, one keyboard and one mouse have different pipe endpoints, and two keyboards have different pipe endpoints. Because the USB endpoint of the USB class device of the opposite end is independent, an effect that the shared data are downloaded from different pipe endpoints as long as the devices are different is achieved.

The shared data do not contain a command which is capable of being recognized by the controller of the USB sharing device, and the USB sharing device does not recognize, differentiate and process the shared data, but only plays a transmission role. This transmission mode is generally called transparent transmission.

The effect of transmitting the shared data from the pipe endpoint to the USB upload endpoint of the other side according to the corresponding relationship may be achieved by making the pipe endpoint and the USB upload endpoint of the other side share a same buffer, or making the pipe endpoint and the USB upload endpoint of the other side have different buffers respectively, and data stored in the buffer of the pipe endpoint are copied into the buffer of the USB upload endpoint of the other side during transmission.

On this basis, by adding similar software and hardware resources in another direction and using the same method, the shared data may also be transmitted from the second computing device to the first computing device by the same transmission method, so that the shared data can be transmitted to the opposite end from both sides.

A USB sharing device is provided, wherein USB recognition information provided by the USB sharing device can be recognized as at least one USB vendor specific class device by the first computing device, or recognized as other USB vendor specific class devices or other USB devices excluding the USB vendor specific class devices; and USB recognition information provided by the USB sharing device can be recognized as at least one USB class device by the second computing device, or recognized as other USB class devices or other USB devices excluding the USB class devices; and the USB sharing device comprises:

a first USB port used for connecting with the first computing device;

a second USB port used for connecting with the second computing device;

a USB download endpoint of one side, which is capable of being allocated with a USB pipe by the first computing device, wherein the USB download endpoint allocated with the USB pipe is defined as a pipe endpoint, a plurality of pipe endpoints are provided, and at least two pipe endpoints are provided; and the pipe endpoint is used for receiving shared data downloaded from the first computing device, the shared data have different usages, and different pipe endpoints are specified for the different usages;

a sharing control unit used for establishing a corresponding relationship between the USB download endpoint of one side and a USB upload endpoint of the other side to make the USB download endpoint of one side in one-to-one correspondence with the USB upload endpoint of the other side;

the USB upload endpoint of the other side used for receiving the shared data transmitted from the corresponding pipe endpoint, and uploading the shared data to the second computing device through the USB upload endpoint of the other side, wherein one side refers to a side connected with the first computing device; and the other side refers to a side connected with the second computing device;

a first shared data acquisition module, which is a software module installed on the first computing device, and used for acquiring shared data of the first computing device and transmitting the shared data to a first driver module;

the first driver module, which is driver software with a pipe transparent transmission function installed on the first computing device, generally provided by a vendor, and used for transmitting the shared data of the first computing device to the specified pipe endpoint through the USB pipe.

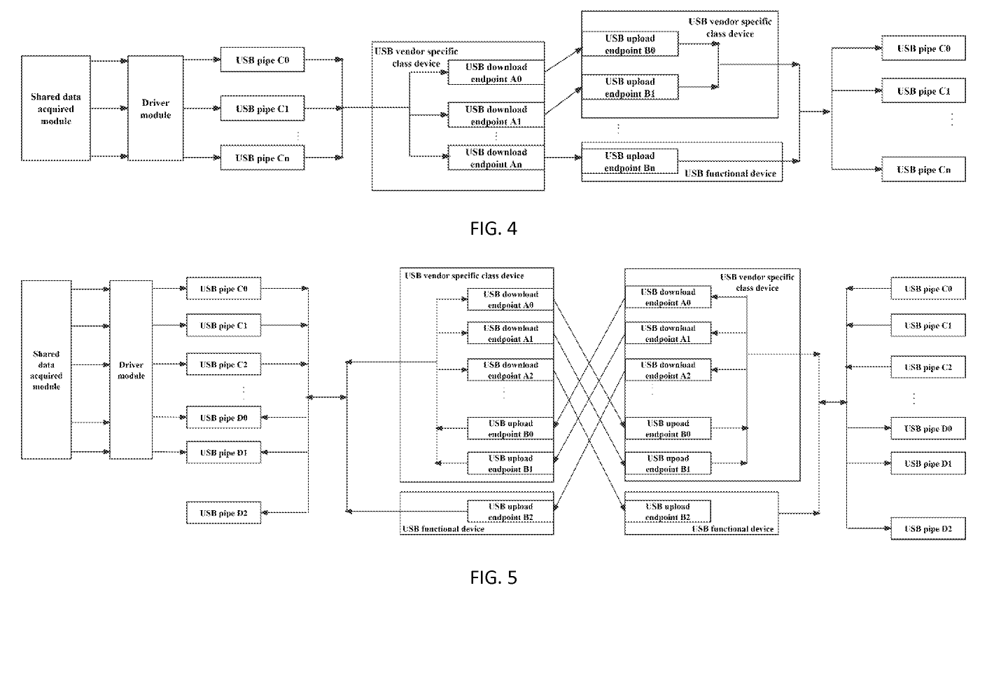

FIG. 4 is a schematic diagram of data transmission of the USB sharing device, and there is data transmission in one direction only, which refers to transmission from the first computing device to the second computing device. The figure shows n pipes, the shared data are downloaded from the first USB port through the corresponding USB pipe and transmitted to specified pipe endpoints, and the pipe endpoints are n USB download endpoints of a left side in the USB sharing device, which are a USB download endpoint A0, a USB download endpoint A1 ... a USB download endpoint An. Because the USB download endpoints of the left side and USB upload endpoints of a right side in the USB sharing device are in one-to-one correspondence, the shared data are correspondingly transmitted to the USB upload endpoints of the right side, which are a USB upload endpoint B0, a USB upload endpoint B1 ... a USB upload endpoint Bn. When the shared data are used for the shared information, the shared data may be transmitted to the USB vendor specific class device of the opposite end, and different information is transmitted to different and corresponding USB upload endpoints, such as the USB upload endpoint B0 and the USB upload endpoint B1, and then uploaded to the second computing device through these USB upload endpoints. When the shared data are used for the shared device, the shared data may be transmitted to the USB class device of the opposite end, and at this time, the shared data are transmitted to the USB upload endpoint Bn, and uploaded to the second computing device through the USB upload endpoint Bn. The USB class device of the opposite end may also have a plurality of USB upload endpoints herein to receive data of different shared devices respectively. The USB vendor specific class device of the opposite end may also have a plurality of USB upload endpoints to receive data of different shared information respectively.. There can be a plurality of USB class devices and USB vendor specific class devices of the opposite end. Based on the principle of the technical solution of the present invention, there may be no USB vendor specific class device at the opposite end, so that the shared information cannot be transmitted, and can only be shared by the devices.

On this basis, by adding similar software and hardware resources in another direction, the transmission of the shared data from the second computing device to the first computing device may also be supported, that is, the transmission of the shared data in two directions is supported, as shown in FIG. 5. The USB sharing device can be recognized as the USB vendor specific class device and the USB class device by the first computing device, or recognized as the USB vendor specific class device and the USB class device by the second computing device. At this time, the USB sharing device further comprises:

a USB download endpoint of the other side, which is capable of being allocated with a USB pipe by the second computing device, wherein the USB download endpoint allocated with the USB pipe is defined as a pipe endpoint, and a plurality of pipe endpoints are provided; and the pipe endpoint is used for receiving shared data downloaded from the second computing device, the shared data have different usages, and different pipe endpoints are specified for the different usages;

a sharing control unit further used for establishing a corresponding relationship between the USB download endpoint of the other side and a USB upload endpoint of one side to make the USB download endpoint of the other side in one-to-one correspondence with the USB upload endpoint of one side;

the USB upload endpoint of one side used for receiving the shared data transmitted from the corresponding pipe endpoint, and uploading the shared data to the first computing device through the USB upload endpoint of one side;

a second shared data acquisition module, which is a software module installed on the second computing device, and used for acquiring shared data of the second computing device and transmitting the shared data to a second driver module;

the second driver module, which is driver software with a pipe transparent transmission function installed on the second computing device, generally provided by a vendor, and used for transmitting the shared data of the second computing device to the specified pipe endpoint through the USB pipe.

The USB sharing device may be recognized as a USB composite device by at least one computing device, which may also be a USB compound device. For example, the USB sharing device contains a USB hub, and a downlink port of the USB hub is connected with at least one USB vendor specific class device, or connected with other USB devices to communicate with the computer.

Further, for the USB composite device, all USB vendor specific class devices, all USB class devices and all USB endpoints may be integrated into a single chip with at least two USB ports, and the above device may be achieved by the USB Interface; and for the USB compound device, all USB hubs, all USB vendor specific class devices, all USB class devices and all USB endpoints may be integrated into a single chip with at least two USB uplink ports, and the above device may be a built-in logic device or a virtual device connected with the downlink port of the USB hub. In addition, the integrated chip may further provide several USB downlink ports for external connection with the USB device. For example, the USB sharing device is a novel data sharing device architecture of a high-speed MCU or SoC with multiple USB endpoints and multiple downlink ports based on a multiple-USB-device controller with a built-in hub architecture, which is combined with the communication transparent transmission method of the present invention, so that the transmission efficiency is higher, the advantage of rapid development of integrated circuit technology is fully utilized, and the demand for a large amount of data shared information can be met.

What is claimed is:

1. A communication transparent transmission method for a USB sharing device comprises the following steps of:
establishing, by the USB sharing device, a corresponding relationship between a USB download endpoint of one side and a USB upload endpoint of the other side to make the USB download endpoint of one side in one-to-one correspondence with the USB upload endpoint of the other side, wherein one side refers to a side connected with a first computing device; and the other side refers to a side connected with a second computing device;
connecting the USB sharing device with the first computing device and the second computing device, and recognizing the USB sharing device as at least one USB vendor specific class device by the first computing device, and as at least one USB class device and at least one USB vendor specific class device by the second computing device; and allocating the USB download endpoint of one side of the USB sharing device with a USB pipe by the first computing device, and defining the USB download endpoint allocated with the USB pipe as a pipe endpoint, wherein a plurality of pipe endpoints are provided;
acquiring, by a first shared data acquisition module, shared data of the first computing device and transmitting the shared data to a first driver module;
transmitting, by the first driver module, the shared data to the specified pipe endpoint through the USB pipe, wherein the shared data have different usages, and different pipe endpoints are specified for the different usages, and the usages of the shared data comprise at least one of being used for a shared device and being used for shared information;
receiving, by the pipe endpoint, the shared data of the first computing device;
transmitting the shared data from the pipe endpoint to the USB upload endpoint of the other side according to the corresponding relationship, and when the shared data are used for the shared information, transmitting the shared data to the specified USB upload endpoint of the other side of the USB vendor specific class device; and when the shared data are used for the shared device, transmitting the shared data to the specified USB upload endpoint of the other side of the USB class device, and uploading the shared data to the second computing device through the USB upload endpoint of the other side.

2. The communication transparent transmission method for the USB sharing device according to claim 1, wherein, when the shared data are used for the shared device, pipe endpoints are different for different devices; and when the shared data are used for the shared information, pipe endpoints are different for different information.

3. The communication transparent transmission method for the USB sharing device according to claim 1, wherein a method for transmitting the shared data from the pipe endpoint to the USB upload endpoint of the other side according to the corresponding relationship comprises: making the pipe endpoint and the USB upload endpoint of the other side share a same buffer.

4. The communication transparent transmission method for the USB sharing device according to claim 2, wherein a method for transmitting the shared data from the pipe endpoint to the USB upload endpoint of the other side according to the corresponding relationship comprises: making the pipe endpoint and the USB upload endpoint of the other side share a same buffer.

5. The communication transparent transmission method for the USB sharing device according to claim 1, wherein a method for transmitting the shared data from the pipe endpoint to the USB upload endpoint of the other side according to the corresponding relationship comprises: making the pipe endpoint and the USB upload endpoint of the other side have different buffers respectively, and copying data stored in the buffer of the pipe endpoint into the buffer of the USB upload endpoint of the other side.

6. The communication transparent transmission method for the USB sharing device according to claim 2, wherein a method for transmitting the shared data from the pipe endpoint to the USB upload endpoint of the other side according to the corresponding relationship comprises: making the pipe endpoint and the USB upload endpoint of the other side have different buffers respectively, and copying data stored in the buffer of the pipe endpoint into the buffer of the USB upload endpoint of the other side.

7. A USB sharing device, wherein the USB sharing device is capable of being recognized as at least one USB vendor specific class device by a first computing device, and capable of being recognized as at least one USB class device and at least one USB vendor specific class device by a second computing device; and comprises:
a first USB port used for connecting with the first computing device;
a second USB port used for connecting with the second computing device;
a USB download endpoint of one side, which is capable of being allocated with a USB pipe by the first computing device, wherein the USB download endpoint allocated with the USB pipe is defined as a pipe endpoint, and a plurality of pipe endpoints are provided; and the pipe endpoint is used for receiving shared data downloaded from the first computing device, the shared data have different usages, different pipe endpoints are specified for the different usages, and the usages of the shared data comprise at least one of being used for a shared device and being used for shared information;
a sharing control unit used for establishing a corresponding relationship between the USB download endpoint of one side and a USB upload endpoint of the other side to make the USB download endpoint of one side in one-to-one correspondence with the USB upload endpoint of the other side, and when the shared data are used for the shared information, transmitting the shared data to the specified USB upload endpoint of the other side of the USB vendor specific class device; and when the shared data are used for the shared device, transmitting the shared data to the specified USB upload endpoint of the other side of the USB class device;
the USB upload endpoint of the other side used for receiving the shared data transmitted from the corresponding pipe endpoint, and uploading the shared data to the second computing device through the USB upload endpoint of the other side, wherein one side refers to a side connected with the first computing device; and the other side refers to a side connected with the second computing device;
a first shared data acquisition module, which is a software module installed on the first computing device, and used for acquiring shared data of the first computing device and transmitting the shared data to a first driver module;
the first driver module, which is driver software with a pipe transparent transmission function installed on the first computing device, and used for transmitting the shared data of the first computing device to the specified pipe endpoint through the USB pipe.

8. The USB sharing device according to claim 7, wherein, when the shared data are used for the shared device, pipe endpoints are different for different devices; and when the shared data are used for the shared information, pipe endpoints are different for different information.

9. The USB sharing device according to claim 7, wherein the pipe endpoint and the USB upload endpoint of the other side share a same buffer.

10. The USB sharing device according to claim 8, wherein the pipe endpoint and the USB upload endpoint of the other side share a same buffer.

11. The USB sharing device according to claim 7, wherein the USB sharing device is capable of being recognized as at least one USB mass storage device by at least one of the first computing device and the second computing device.

12. The USB sharing device according to claim 8, wherein the USB sharing device is capable of being recognized as at least one USB mass storage device by at least one of the first computing device and the second computing device.

13. The USB sharing device according to claim 7, wherein the USB sharing device is capable of being recognized as at least one USB vendor specific class device and at least one USB class device by the first computing device, and also capable of being recognized as at least one USB vendor specific class device and at least one USB class device by the second computing device; and further comprises:
a USB download endpoint of the other side, which is capable of being allocated with a USB pipe by the second computing device, wherein the USB download endpoint allocated with the USB pipe is defined as a pipe endpoint, and a plurality of pipe endpoints are provided; and the pipe endpoint is used for receiving shared data downloaded from the second computing device, the shared data have different usages, and different pipe endpoints are specified for the different usages;
a sharing control unit further used for establishing a corresponding relationship between the USB download endpoint of the other side and a USB upload endpoint of one side to make the USB download endpoint of the other side in one-to-one correspondence with the USB upload endpoint of one side;
the USB upload endpoint of one side used for receiving the shared data transmitted from the corresponding pipe endpoint, and uploading the shared data to the first computing device through the USB upload endpoint of one side;
a second shared data acquisition module, which is a software module installed on the second computing device, and used for acquiring shared data of the second computing device and transmitting the shared data to a second driver module;
the second driver module, which is driver software with a pipe transparent transmission function installed on the second computing device, and used for transmitting the shared data of the second computing device to the specified pipe endpoint through the USB pipe.

14. The USB sharing device according to claim 8, wherein the USB sharing device is capable of being recognized as at least one USB vendor specific class device and at least one USB class device by the first computing device, and also capable of being recognized as at least one USB vendor specific class device and at least one USB class device by the second computing device; and further comprises:
a USB download endpoint of the other side, which is capable of being allocated with a USB pipe by the second computing device, wherein the USB download endpoint allocated with the USB pipe is defined as a pipe endpoint, and a plurality of pipe endpoints are provided; and the pipe endpoint is used for receiving shared data downloaded from the second computing device, the shared data have different usages, and different pipe endpoints are specified for the different usages;
a sharing control unit further used for establishing a corresponding relationship between the USB download endpoint of the other side and a USB upload endpoint of one side to make the USB download endpoint of the other side in one-to-one correspondence with the USB upload endpoint of one side;
the USB upload endpoint of one side used for receiving the shared data transmitted from the corresponding pipe endpoint, and uploading the shared data to the first computing device through the USB upload endpoint of one side;
a second shared data acquisition module, which is a software module installed on the second computing device, and used for acquiring shared data of the second computing device and transmitting the shared data to a second driver module;
the second driver module, which is driver software with a pipe transparent transmission function installed on the second computing device, and used for transmitting the shared data of the second computing device to the specified pipe endpoint through the USB pipe.
